(19) United States
(12) Patent Application Publication
(10) Pub. No.: US 2010/0274855 A1
(43) Pub. Date: Oct. 28, 2010

(54) SCHEDULING EVENTS WITH LOCATION MANAGEMENT

(75) Inventor: Tomas Karl-Axel Wassingbo, Lund (SE)

Correspondence Address: SNYDER, CLARK, LESCH & CHUNG, LLP, 950 Herndon Parkway, Suite 365, HERNDON, VA, 20170, US

(73) Assignee: SONY ERICSSON MOBILE COMMUNICATIONS AB, Lund (SE)

(21) Appl. No.: 12/428,014

(22) Filed: Apr. 22, 2009

(51) Int. Cl. G06F 15/16

(52) U.S. Cl. 709/206

(57) ABSTRACT

A computer-implemented method may include associating each of a plurality of guests with an event time and an event location, wherein the association of each of the plurality of guests includes information indicating whether the guest is expected to be present at the event location at the event time, and wherein the event time and the event location is the same for each of the plurality of guests. The method may also include associating each of a plurality of mobile devices with a different one of the plurality of guests that is associated with information indicating that the guest is expected to be present at the event location at the event time. Further, the method may include receiving a location update message from each of the mobile devices, wherein each location update message indicates a location of the corresponding mobile device, and displaying an indication of the location of the each of the mobile devices as indicative of the location of the associated guest.

### BACKGROUND

Personal information management (PIM) applications may allow users to coordinate schedules and calendars. These calendars may indicate who has been invited to an event, who has accepted or declined the invitation, and the time and location of the event. These applications, however, do not have capabilities with respect to determining or managing location information with respect to the invited guests.

### SUMMARY

In one embodiment, a computer-implemented method is provided. The computer-implemented method may include associating each of a plurality of guests with an event time and an event location, wherein the association of each of the plurality of guests includes information indicating whether the guest is expected to be present at the event location at the event time, and wherein the event time and the event location is the same for each of the plurality of guests. The method may also include associating each of a plurality of mobile devices with a different one of the plurality of guests that is associated with information indicating that the guest is expected to be present at the event location at the event time. Further, the method may include receiving a location update message from each of the mobile devices, wherein each location update message indicates a location of the corresponding mobile device, and displaying an indication of the location of the each of the mobile devices as indicative of the location of the associated guest.

In another aspect, the computer-implemented method may include determining, for one of the mobile devices, a distance between the location of the one mobile device and the event location and determining, based on the distance, whether the guest associated with the one mobile device, when collocated with the one mobile device, is unlikely to be present at the event location at the event time. The method may include displaying the determination of whether the guest associated with the one mobile device is unlikely to be present at the event location at the event time.

In another aspect, the computer-implemented method may include sending a location request message to each of the mobile devices, wherein each location request message requests the location of the corresponding mobile device, wherein the location update message received from each of the mobile devices is in response to the location request message sent to each of the mobile devices.

In another aspect, the computer-implemented method may include sending the location request message at a set period of time before or after the event time, wherein the set period of time is one of approximately 5 minutes, 10 minutes, 15 minutes, 20 minutes, 30 minutes, 45 minutes, or 60 minutes.

In another aspect, the computer-implemented method may include analyzing, after receiving the location update message from each of the mobile devices, the location of each mobile device relative to the event location; and recommending a new event location based on the analysis.

In another aspect, the computer-implemented method may include recommending the new event location based on stored location preferences of one or more of the plurality of guests or based on previous event locations associated with one or more of the plurality of guests.

In one embodiment, a system is provided. The system may include a database to store an association between each of a plurality of guests and an event time and an event location, wherein the association of each of the plurality of guests indicates whether the guest is expected to be present at the event location at the event time. The database may also store an association between each of a plurality of mobile devices and a different one of the plurality of guests associated with information indicating that the guest is expected to be present at the event location at the event time. The system may include a receiver to receive a location update message from one or more of the plurality of mobile devices, wherein each location update message indicates a location of the corresponding mobile device. The system may also include a display to show an indication of the location of the one or more mobile devices and the associated one of the plurality of guests.

In another aspect, the system may include a processor to determine, for each of the one or more mobile devices, a distance between the location of the mobile device and the event location, and determine, based on the distance, whether one or more of the guests, when collocated with the associated mobile device, is unlikely to be present at the event location at the event time. The display may shows one or more of the determinations.

In another aspect, the system may include a transmitter to send a location request message to the one or more mobile devices, wherein each location request message requests the location of the corresponding mobile device, wherein the location update messages received from the one or more mobile devices is in response to the transmitter sending the location request message to the one or more mobile devices.

In another aspect, the transmitter sends the location request message at a set period of time before or after the event time, wherein the set period of time is one of approximately 5 minutes, 10 minutes, 15 minutes, 20 minutes, 30 minutes, 45 minutes, or 60 minutes.

In another aspect, the processor analyzes, after receiving the location update message from the one or more mobile devices, the location of each of the one or more mobile devices relative to the event location, and recommends a new event location based on the analysis.

In another aspect, the processor recommends the new event location based on stored location preferences of one or more of the plurality of guests or based on previous event locations associated with one or more of the plurality of guests.

In one embodiment, a mobile device is provided. The mobile device may include a receiver to receive an invitation to be present at an event location at an event time; and a transmitter to send a response to the invitation to a sync server, wherein the response includes an indication that a guest associated with the mobile device is expected to be present at the event location at the event time, wherein the transmitter is further configured to send a location update message to the sync server indicating a location of the mobile device, wherein the location of the mobile device is indicative of the location of the guest associated with the mobile device.

In another aspect, the receiver is further configured to receive a request for the location of the mobile device, wherein the transmitter sends the location update message is in response to the request.

In another aspect, the receiver is further configured to receive a recommendation of a new event location based on stored location preferences of associated with the mobile device or based on previous event locations associated with the mobile device.

In one embodiment, a computer-readable medium including computer-executable instructions is provided. The instructions may provide for associating each of a plurality of guests with an event time and an event location; storing information indicating that one or more of the plurality of guests is expected to be present at the event location at the event time; associating each of one or more mobile devices with a different one of the one or more guests that indicate that the guest is expected to be present at the event at the event location. The instructions may also provide for receiving a location update message from each of the one or more mobile devices, wherein each location update message indicates a location of the corresponding mobile device; and displaying an indication of the location of each of the one or more mobile devices as indicative of the location of the associated guest.

In another aspect, the instructions may provide for determining a distance between the location of one of the mobile devices and the event location; determining, based on the distance, whether the guest associated with the one of the mobile devices, when collocated with the one of the mobile devices, is unlikely to be present at the event location at the event time; and displaying the determination.

In another aspect, the instructions may provide for sending a location request message to the one or more mobile devices, wherein the location request message requests the location of the corresponding mobile device, and wherein the location update message received from the one or more mobile devices is in response to sending the location request message to the one or more mobile devices.

In another aspect, sending the location request message includes sending the location request message at a set time before or after the event time, wherein the set period of time is one of approximately 5 minutes, 10 minutes, 15 minutes, 20 minutes, 30 minutes, 45 minutes, or 60 minutes.

In another aspect, the instructions may provide for analyzing, after receiving the location update message from the one or more mobile devices, the location of the one or more mobile devices relative to the event location; and recommending a new event location based on the analysis.

### BRIEF DESCRIPTION OF THE DRAWINGS

The accompanying drawings, which are incorporated in and constitute a part of this specification, illustrate one or more embodiments described herein and, together with the description, explain the embodiments. In the drawings:

FIG. 1 is a block diagram of an exemplary environment for scheduling an event with location management;

FIG. 2 is a diagram of an exemplary device that may implement embodiments described herein;

FIG. 3 is a block diagram of exemplary components of a client computing module;

FIG. 4 is a block diagram of exemplary components of a server computing module;

FIG. 5 is a block diagram of an exemplary place table;

FIG. 6 is a block diagram of an exemplary event table;

FIG. 7 is a block diagram of an exemplary locating parameters table;

FIG. 8 is a block diagram of an exemplary location status table;

FIG. 9 is flowchart of an exemplary process for event scheduling with location management; and

FIG. 10 is a flowchart of an exemplary process for scheduling events with location management.

### DETAILED DESCRIPTION

The following detailed description refers to the accompanying drawings. The same reference numbers in different drawings may identify the same or similar elements.

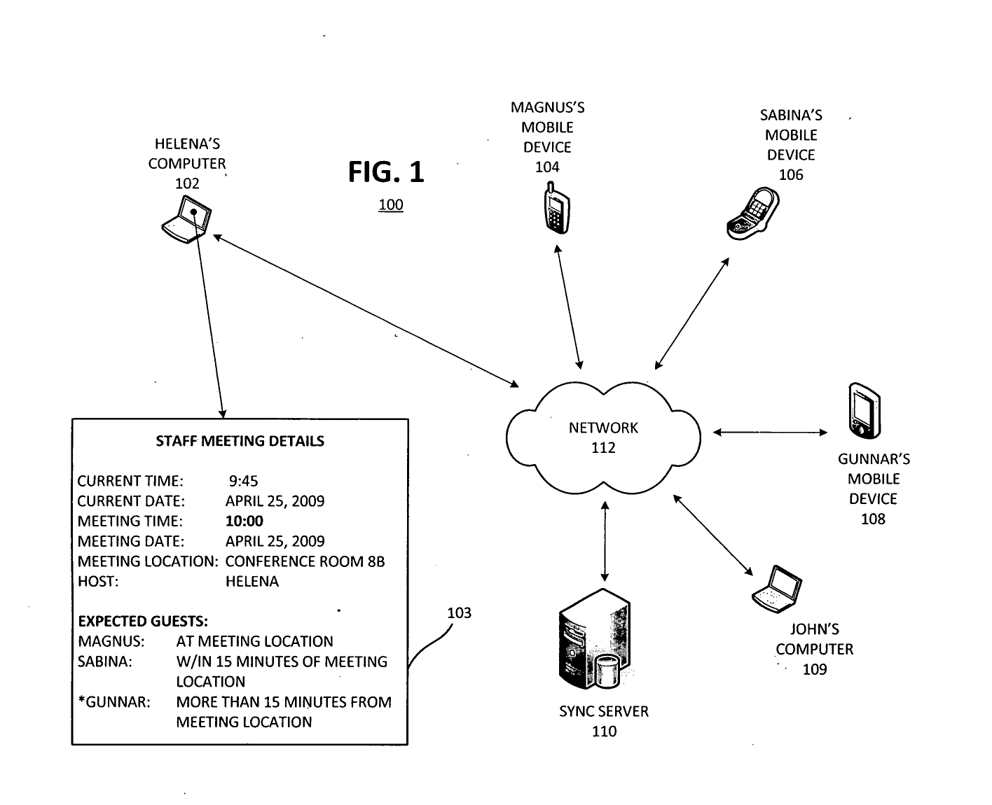

Embodiments disclosed herein may allow for guests to an event to monitor the location of other guests at times leading up to the event. For example, FIG. 1 is a block diagram of an exemplary environment 100 for scheduling an event with location management. As shown in FIG. 1, Helena's computer 102 displays a status screen 103 that indicates—15 minutes before a staff meeting event, for example—that Magnus has already arrived at the staff meeting, Sabina is within 15 minutes of arrival, and Gunnar will apparently be late.

Environment 100 may include Helena's computer 102, Magnus's mobile device 104, Sabina's mobile device 106, Gunnar's mobile device 108, John's computer 109, sync server 110, and network 112. Network 112 may allow all the devices in environment 100 to communicate with each other.

Each of Helena's and John's computers 102 and 109 may include one or more computer systems for hosting programs, databases, and/or applications. Computers 102 and 109 may include a laptop, desktop, or any other type of computing device. Computers 102 and 109 may include client application programs, such as a personal information management (PIM) application to allow a user (e.g., Helena) to send and receive email and text messages, schedule events with a calendar, and manage contacts and tasks. Examples of PIM applications include Novell Evolution and Microsoft Outlook, both of which may connect to Microsoft Exchange servers (e.g., using ActiveSync) or similar servers. Computers 102 and 109 may include a browser application program for navigating a network, such as the Internet or network 112.

Mobile devices 104-108 may allow users (e.g., Magnus, Sabina, and Gunnar) to initiate or receive telephone calls or send messages to other user devices, such as any other mobile device 104-108. Mobile devices 104-108 may communicate with other devices via base transceiver stations (BTSs, not shown) using a wireless communication protocols, e.g., GSM (Global System for Mobile Communications), CDMA (Code-Division Multiple Access), WCDMA (Wideband CDMA), GPRS (General Packet Radio Service), EDGE (Enhanced Data Rates for GSM Evolution), etc. In one embodiment, mobile devices 104-108 may communicate with other devices using wireless network standards such as WiFi (e.g., IEEE 802.11x) or WIMAX (e.g., IEEE 802.16x). In yet another embodiment, mobile devices 104-108 may communicate with other devices via a wired network using, for example, a public-switched telephone network (PSTN) or an Ethernet network. Helena's computer 102 and John's computer 109 may also perform the same functions as mobile devices 104-108.

Sync server 110 may include one or more computer systems for hosting programs, databases, and/or applications. For example, sync server 110 may include server software that provides email, messaging, calendar management, contact management, task management, and synchronization services to client devices, such as devices 102-109. Sync server 110 may provide functions for groups of users, such as shared email inboxes, common calendars, shared calendars, and meeting time allocation. An example of such server software includes Microsoft Exchange Server or a Linux email server. In some instances, one or more of devices 102-109 may also perform the functions of sync server 110.

Network 112 may include one or more wired and/or wireless networks that may receive and transmit data, sound (e.g., voice), or video signals. Network 112 may include one or more BTSs (not shown) for transmitting or receiving wireless signals to/from mobile communication devices, such as devices 104-108, using wireless protocols (e.g., GSM, CDMA, WCDMA, GPRS, EDGE, etc). Network 112 may further include one or more packet switched networks, such as an Internet protocol (IP) based network, a local area network (LAN), a wide area network (WAN), a personal area network (PAN), a virtual private network (VPN), or another type of network that is capable of carrying data. Network 112 may also include one or more circuit-switched networks, such as a PSTN.

The exemplary configuration illustrated in FIG. 1 is provided for simplicity. In other embodiments, environment 100 may include more, fewer, or different devices. Environment 100 may also include thousands, if not hundreds of thousands, of user devices, such as devices 102-109, and as many sync servers 110. Moreover, one or more devices 102-110 may perform one or more functions of any other device in environment 100.

Although FIG. 1 shows devices 102-110 coupled to network 112 in a particular configuration, these devices may also be arranged in other configurations, either coupling directly with each other or through one or more networks, such that any one of devices 102-110 may communicate with any other one of devices 102-110.

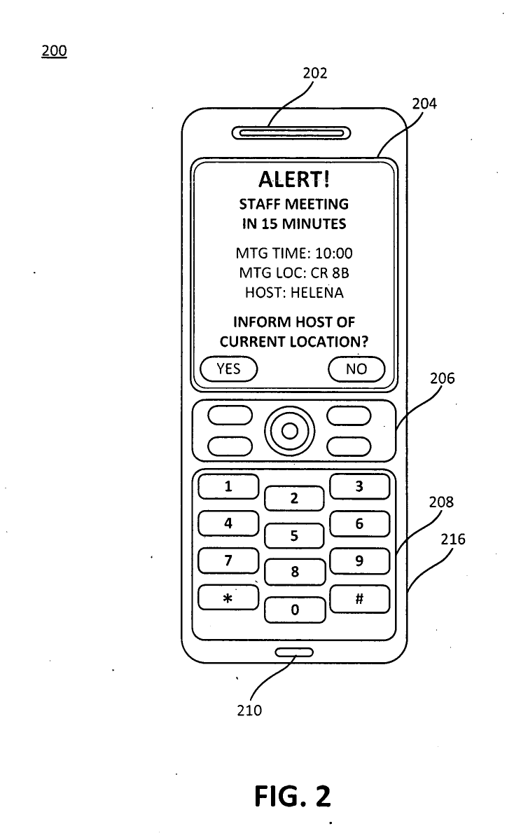

FIG. 2 is a diagram of an exemplary device 200 that may implement embodiments described herein. In one embodiment, mobile devices 104-108 and computer 102 and 109 may each correspond to a device such as device 200. Device 200 may include any of the following devices: a mobile telephone; a cellular phone; an electronic notepad, a laptop, and/or a personal computer; a personal digital assistant (PDA) including a telephone; a gaming device or console; a music playing device; a Global Positioning System (GPS) device; a digital camera; or another type of computational or communication device.

As shown in FIG. 2, device 200 may include a speaker 202, a display 204, control buttons 206, a keypad 208, a microphone 210, and a housing 216. Speaker 202 may provide audible information to a user of device 200. Display 204 may provide visual information to the user, such as the image of a caller, text, video images, or pictures. Control buttons 206 may permit the user to interact with device 200 to cause device 200 to perform one or more operations, such as place or receive a telephone call. Keypad 208 may include a telephone keypad. Microphone 210 may receive sound, e.g., the user voice during a telephone call.

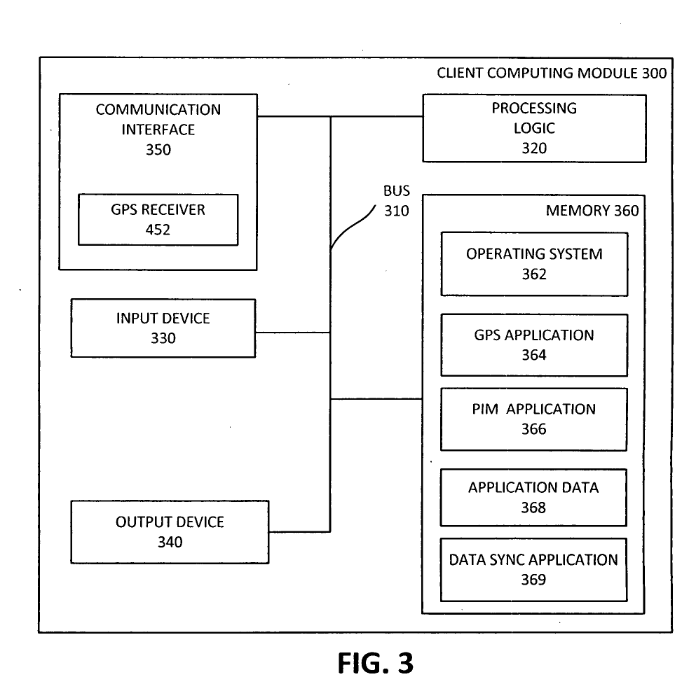

FIG. 3 is a block diagram of exemplary components of a client computing module 300. Computers 102 and 109 and mobile devices 104-108 may each include one or more computing modules 300. Client computing module 300 may include a bus 310, processing logic 320, an input device 330, an output device 340, a communication interface 350, and a memory 360. Client computing module 300 may include other components (not shown) that aid in receiving, transmitting, and/or processing data. Moreover, other configurations of components in client computing module 300 are possible.

Bus 310 may include a path that permits communication among the components of client computing module 300. Processing logic 320 may include any type of processor or microprocessor (or groups of processors or microprocessors) that interprets and executes instructions. In other embodiments, processing logic 320 may include one or more application-specific integrated circuits (ASICs) or field-programmable gate arrays (FPGAs).

Input device 330 may include a device that permits a user to input information into client computing module 300, such as a keyboard (e.g., control keys 206 and/or keypad 208), a mouse, a pen, a microphone (e.g., microphone 210), a camera, a touch-screen display (e.g., display 204), etc. Input device 330 may also include an accelerometer that may allow client computing module 300 to measure acceleration and movement of the device that includes the client computing module 300. Output device 340 may include a device that outputs information to the user, such as a display (e.g., display 204), a speaker (e.g., speaker 202), etc. Output device 340 may also include a vibrator to alert a user.

Input device 330 and output device 340 may allow the user to activate a particular service or application. Input device 330 and output device 340 may allow the user to receive and view a menu of options and select from the menu options. The menu may allow the user to select the functions or services associated with applications executed by client computing module 300.

Communication interface 350 may include a transceiver that enables client computing module 300 to communicate with other devices or systems. Communication interface 350 may include a GPS receiver 452 for receiving signals from orbiting satellites or stationary towers for determining the position of client computing module 300.

Communications interface 350 may include a network interface card, e.g., Ethernet card, for wired communications or a wireless network interface (e.g., a WiFi) card for wireless communications. Communication interface 350 may implement a wireless communication protocol, e.g., GSM, CDMA, WCDMA, GPRS, EDGE, etc. Communication interface 350 may also include, for example, a universal serial bus (USB) port for communications over a cable, a Bluetooth™ wireless interface for communicating with Bluetooth devices, a near-field communication (NFC) interface, etc.

Memory 360 may include a random access memory (RAM) or another type of dynamic storage device that may store information and instructions, e.g., an application, for execution by processing logic 320; a read-only memory (ROM) device or another type of static storage device that may store static information and instructions for use by processing logic 320; or some other type of magnetic or optical recording medium and its corresponding drive, e.g., a hard disk drive (HDD), a solid state drive (SSD) or memory, for storing information and/or instructions.

Memory 360 may include an operating system 362, which may include software instructions for managing hardware and software resources of device 200. Operating system 362 may include Symbian, Android, Windows Mobile, etc. Memory 360 may also include a GPS application 364 that interacts with GPS receiver 452 to determine the location of client computing module 300, and thus the location of the device housing client computing module 300. Memory 360 may also include a PIM application 366 for handling event information (e.g., a calendar), such as the time and location of meetings. Memory 360 may also store application data 368, such as event information for PIM application 366 or location information for GPS application 364.

Memory 360 may also include a data synchronization (sync) application 369 that may synchronize data, such as application data 368, among multiple memories or multiple devices. In one embodiment, data sync application 369 may support the ActiveSync protocol, a data synchronization protocol developed by Microsoft. In one embodiment, GPS application 364 and data sync application 369 may synchronize or send location information to other applications or devices using the GPS Exchange Format (GPX), which is an XML schema for describing GPS data. GPX data may be sent over a network using the Extensible Messaging and Presence Protocol (XMPP) over a Transmission Control Protocol (TCP) session, for example.

Memory 360 may also include other applications having hardware and/or software components for performing other tasks. For example, memory 360 may include other PIM applications, such as an address book application, an email client application, or an instant messaging application. Memory 360 may include also a browser application for browsing a network, such as the Internet, for example.

Client computing module 300 may perform operations, as described herein, in response to processing logic 320 executing software instructions store in a computer-readable medium, such as memory 360. A computer-readable medium may be defined as a physical or logical memory device. The software instructions may be read into memory 360 from another computer-readable medium or from another device via communication interface 350. The software instructions contained in memory 360 may cause processing logic 320 to perform processes that are described below.

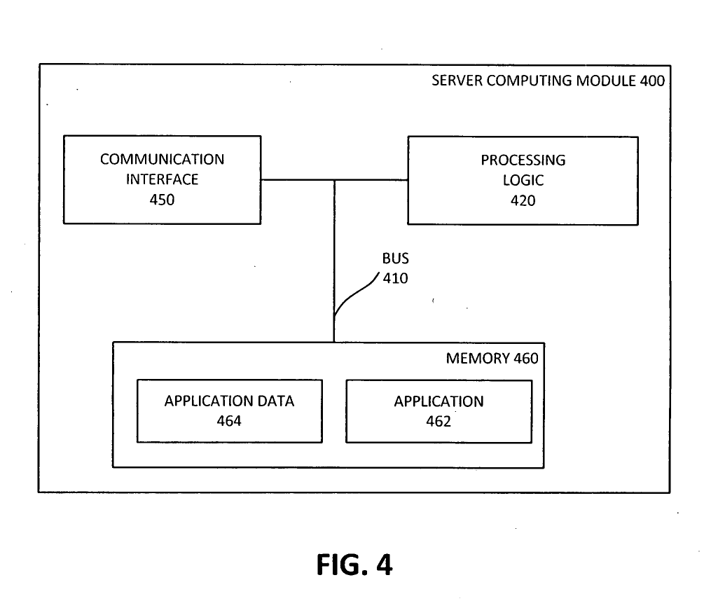

FIG. 4 is a block diagram of exemplary components of a server computing module 400. Sync server 110 may include one or more server computing modules (e.g., a rack of server computer modules), such as computing module 400. Server computing module 400 may include a bus 410, processing logic 420, a communication interface 450, and a memory 460. Server computing module 400 may include other components (not shown) that aid in receiving, transmitting, and/or processing data. Moreover, other configurations of components in module 400 are possible.

Bus 410 may include a path that permits communication among the components of module 400. Processing logic 420 may include any type of processor or microprocessor (or groups of processors or microprocessors) that interprets and executes instructions. In other embodiments, processing logic 420 may include one or more ASICs or FPGAs or the like.

Communication interface 450 may include a transceiver that enables module 400 to communicate with other devices or systems. Communications interface 450 may include a network interface card, e.g., Ethernet card, for wired communications or a wireless network interface (e.g., a WiFi card) for wireless communications.

Communication interface 450 may also include, for example, a USB port for communications over a cable, a Bluetooth wireless interface for communicating with Bluetooth devices, a NFC interface, etc. Communication interface 450 may implement a wireless communication protocol, e.g., GSM, CDMA, WCDMA, GPRS, EDGE, etc. Communication interface 450 may be coupled to an antenna for transmission and reception of signals.

Memory 460 may include a RAM or another type of dynamic storage device that may store information and instructions, e.g., an application that may be executed by processing logic 420 and application data. For example, memory 460 may include a PIM server application 462 and PIM data 464 for multiple users. PIM server application 462 may include an Outlook Exchange Server that acts as an email server and provides a calendar for many users. PIM server application 462 may allow for synchronizing data between a client application and PIM server application 462 and/or between multiple client applications (e.g., using the ActiveSync protocol). PIM server application 462 may receive location data (e.g., GPX data) from mobile devices over a communication protocol (e.g., XMPP and/or TCP). Memory 460 may include a ROM device or another type of static storage device that may store static information and instructions for use by processing logic 420; and/or some other type of magnetic or optical recording medium, e.g., a HDD or SSD, for storing information and/or instructions.

Module 400 may perform certain operations, as described in detail below, in response to processing logic 420 executing software instructions stored in a computer-readable medium, such as memory 460. The software instructions may be read into memory 460 from another computer-readable medium or from another device via communication interface 450. The software instructions contained in memory 460 may cause processing logic 420 to perform processes that are described below.

### Exemplary Tables

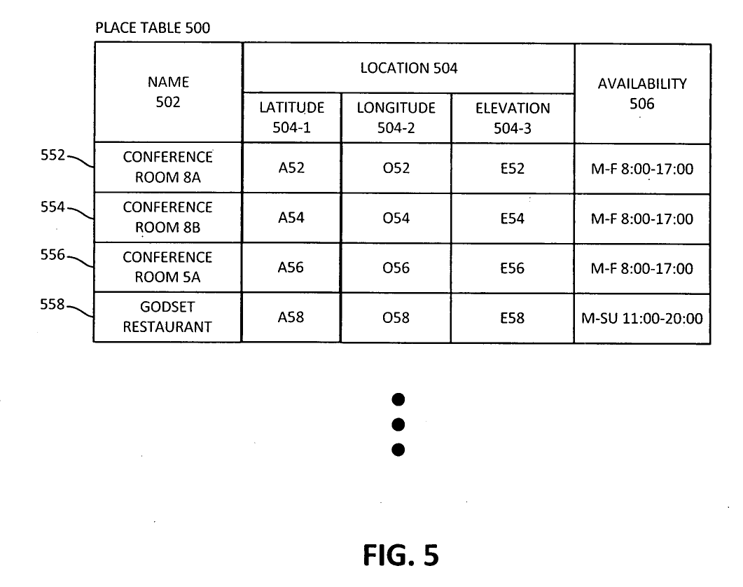

FIG. 5 is a block diagram of an exemplary place table 500 (e.g., a database). Place table 500 may store information related to meeting or event places, locations, or venues, such as the location and availability of the meeting or event place. Each entry (e.g., record) in place table 500 may include information regarding a different place to which a host of an event could invite guests. Place table 500 may be stored in sync server 110 (e.g., in memory 460). In other embodiments, place table 500 may also be stored in other devices in environment 100, such as computers 102 or 109 or a mobile device (e.g., one of devices 104-108).

Place table 500 may include a name field 502, a location field 504, and an availability field 506. Name field 502 may include the name or description of the meeting place. For example, place table 500 includes the following names: Conference Room 8A, Conference Room 8B, Conference Room 5A, and Godset Restaurant.

Location field 504 may specify the location of the corresponding place described in name field 502. For example, location field 504 may include a latitude field 504-1, a longitude field 504-2, and an elevation field 504-3. Latitude field 504-1 may specify the latitude of the corresponding meeting place, longitude field 504-2 may specify the longitude of the corresponding meeting place, and elevation field 504-2 may specify the elevation of the corresponding meeting place. Parameters other than latitude, longitude, and elevation may be used for specifying the location of the corresponding place. For example, street locations and addresses may be stored in location field 604.

Availability field 506 may specify the availability of the corresponding meeting place. For example, record 552 indicates that conference room 8A may only be available from Monday through Friday, 8:00 through 17:00.

Place table 500 may include additional, different, or fewer fields than illustrated in FIG. 5. For example, place table 500 may include a booked field that may include the date and time that the corresponding meeting place is not available because it has already been booked, e.g., reserved, for an event. As another example, place table 500 may include an event type field that describes the type of event that occurs at the corresponding place. For example, a conference room may include an event type of BUSINESS, whereas Godset restaurant may include an event type field of SOCIAL.

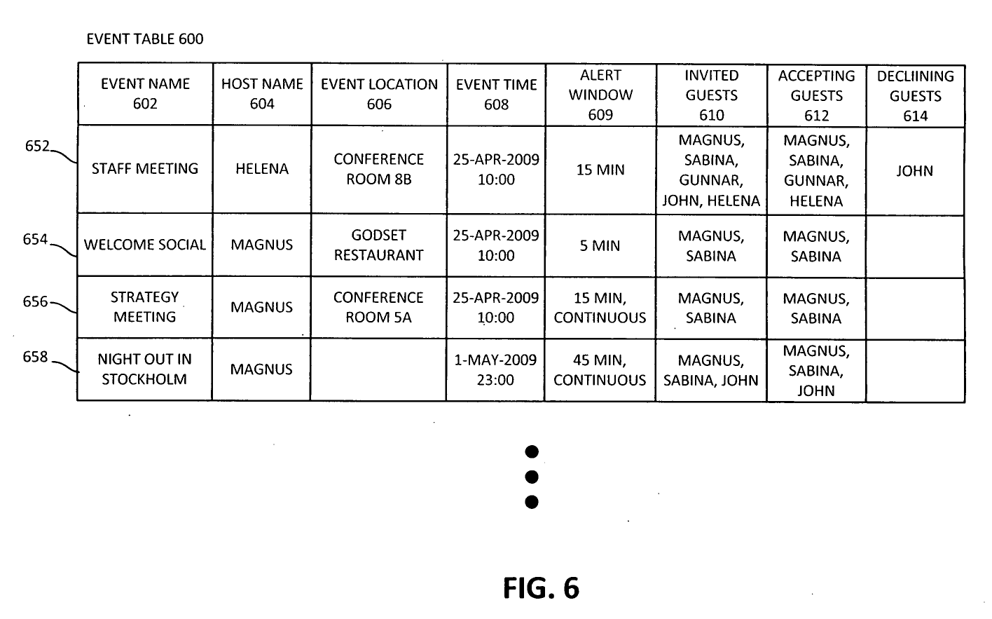

FIG. 6 is a block diagram of an exemplary event table 600. Event table 600 may store information related to scheduled events, such as the location, time, host name, and guest names for an event. Each entry (e.g., record) in event table 600 may include information regarding a different event. Event table 600 may be stored in sync server 110 (e.g., in memory 460). In other embodiments, event table 600 may also be stored in other devices in environment 100, such as computers 102 and 109 or mobile devices 104-108.

Event table 600 may include an event name field 602, a host name field 504, an event location field 606, an event time field 608, an alert window field 609, an invited guests field 610, an accepting guests field 612, and a declining guests field 614.

Event name field 602 may include the name or description of the event. For example, event table 600 includes the following meeting names: Staff Meeting, Welcome Social, Strategy Meeting, and Night Out in Stockholm. As an example, the event in record 652 is for a meeting of Helena's staff (e.g., STAFF MEETING). As another example, the event in record 658 is for a social gathering in Stockholm (e.g., NIGHT OUT IN STOCKHOLM).

Host name field 604 may identify the person who is hosting the meeting, e.g., the person who called the meeting or the person in charge of the meeting. Consistent with the example of FIG. 1, Helena is the host of the staff meeting described by record 652.

Event location field 606 may identify the location of the corresponding event. In exemplary event table 600, locations are indicated by a name that corresponds to an entry in meeting place table 500. In another embodiment, event location field 606 may also or alternatively include the latitude, longitude, and elevation of the corresponding event, similar to location field 504. Consistent with the example of FIG. 1, event table 600 indicates that a Staff Meeting (e.g., record 652) is scheduled to take place in Conference Room 8B.

Event time field 608 may specify the date and time of the corresponding event. Consistent with the example of FIG. 1, event table 600 indicates that the Staff Meeting (e.g., record 652) is scheduled to take place on Apr. 25, 2009, at 10:00.

Alert window field 609 may specify a period of time before the time of the corresponding event that the location of accepting guests 612 (described below) should be determined. For example, record 652 indicates that the location of accepting guests for the Staff Meeting (record 652) should be determined 15 minutes before the start of the meeting. Helena, the host of the Staff Meeting, may find this information useful at that time. On the other hand, the location of accepting guests for the Welcome Social event (record 654) may be determined 5 minutes before the start of the event. In the case of the Strategy Meeting, the location may be determined 15 minutes before the event, but on a continuous basis (as indicated by the tag CONTINUOUS) from that time until all accepting guests arrive at the event, for example. Alert window field 609 may specify other values, such as 10 minutes, 20 minutes, 30 minutes, 45 minutes, 60 minutes, or greater (e.g., 2 hours).

Invited guests field 610 may specify the people invited to join the corresponding event. Accepting guests field 612 may specify which of the invited guests accepted the invitation to attend the corresponding event. In other words, accepting guests field 610 indicates that the corresponding guest is expected to be present at the event (i.e., physically appear at the event location at the event time). Declining guests field 614 may specify which of the invited guests declined the invitation to attend the corresponding event. In other words, declining guests field 614 indicates that the corresponding guest is not expected to be present at the event (i.e., physically appear at the event location at the event time). Consistent with the example of FIG. 1, event table 600 indicates that Magnus, Sabina, Gunnar, John, and Helena were invited to the Staff Meeting (e.g., record 652, fiend 610) and that Magnus, Sabina, Gunnar, and Helena have accepted the invitation (field 612). Event table 600 also indicates that John declined the invitation (field 614). A guest listed in invited guest field 610, but not in accepting guest field 612 or declining guest field 614, indicates that it is unknown whether that guest is or is not expected to be present at the event. Thus, an indication of whether an invited guest is to be present at the corresponding event may include one or more of: (1) an indication that the guest is expected to be present; (2) an indication that the guest is not expected to be present; or (3) an indication that it is unknown whether the guest is or is not expected to be present.

Event table 600 may include additional, different, or fewer fields than illustrated in FIG. 6. For example, event table 600 may include an event type field that describes the type of event scheduled, e.g., a business event, a social event, a marketing event, etc. For example, a record 652 for the Staff Meeting may include a meeting type of BUSINESS, whereas record 654 for the Welcome Social at Godset Restaurant may include an event type field of SOCIAL.

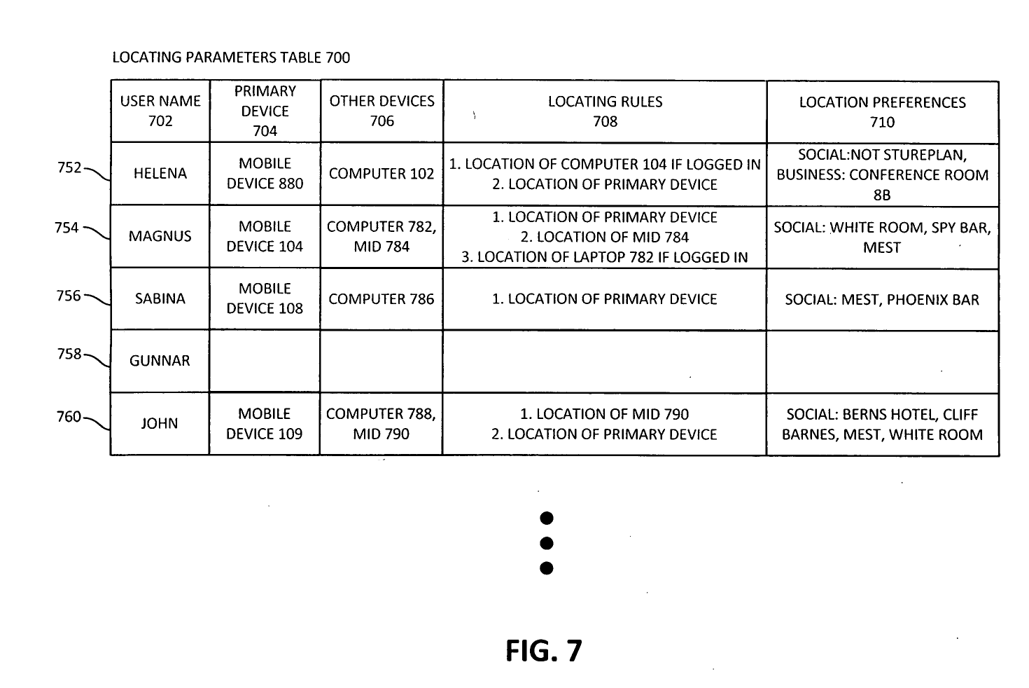

FIG. 7 is a block diagram of an exemplary locating parameters table 700 (or “parameters table 700”). Parameters table 700 may store information related to finding the location of accepting guests for an event. Each entry (e.g., record) in parameters table 700 may include information regarding locating a different guest. Parameters table 700 may be stored in sync server 110 (e.g., in memory 460). In other embodiments, parameters table 600 may also be stored in another device in environment 100, such as computers 102 or 109 or a mobile device (e.g., one of devices 104-108).

Parameters table 700 may include a user name field 702, a locating device field 704, an other devices field 706, a locating rules field 708, and a location preferences field 710. Parameters table 700 may include additional, different, or fewer fields than illustrated in FIG. 7.

User name field 702 may include the name of a user that may attend events described in event table 600. For example, parameters table 700 includes the following user names: Helena, Magnus, Sabina, Gunnar, and John.

Primary device 704 may identify the user device that may likely be collocated with the corresponding user. For example, as shown in record 754, Magnus may typically carry mobile device 104 and, therefore, mobile device 104 may be identified in field 704 as a collocated device. In this case, the location of mobile device 104 is likely the same as the location of Magnus. In other words, if you know the location of mobile device 104, then you likely know the location of Magnus. In this example, the device identified in primary device field 704 is a mobile device that is carried by the corresponding user.

Other devices field 706 may identify user devices, other than primary device 704, associated with the corresponding user. Although the device associated with primary device 704 may imply the location of the corresponding user, in some situations the location of devices identified in other devices field 706 may also help determine the location of the corresponding user.

Locating rules field 708 may describe rules for identifying the location of the corresponding user. For example, record 754, corresponding to user Magnus, includes three rules. In this example, the first rule may have a higher priority than the second rule, and the second rule may have a higher priority than the third rule, and so forth. In other words, the second rule may apply if the first rule does not result in a location for Magnus. Likewise, the third rule may apply if the first and second rules do not result in a location for Magnus.

For example, the first rule for Magnus (record 754) indicates that he may be collocated with his primary device, which is mobile device 104 as defined in primary device field 704. It may be, however, that the location of mobile device 104 is unknowable or uncertain because mobile device 104 is indoors (e.g., GPS receiver 452 cannot receive signals from the satellites) or because mobile device 104 is turned off. In this case, the second rule for Magnus indicates that he may be collocated with his mobile internet device 784 (MID, not shown). If MID 784 cannot be located, then the third rule for Magnus indicates that he may be collocated with laptop 782 (not shown) if he is logged into the network.

Location preferences field 710 may indicate the preferences of the corresponding user name. For example, according to record 752, Helena particularly prefers Conference Room 8B for business meetings. According to record 754, Magnus prefers the White Room, Spy Bar, and Mest for social gatherings. According to record 756, Sabina prefers Mest and Phoenix Bar for social gatherings. And, according to record 760, John prefers the Berns Hotel, Cliff Barnes, White Room, and Mest for social gatherings. According to record 752, Helena's only location preference for social events is that the location is anywhere other than Stureplan, Stockholm. In one embodiment, location preferences 710 may be generated based on the history of the user. For example, if Sabina often goes to Mest, then Mest may automatically appear in her preferences.

In one embodiment, a user may specify a primary device, other devices, and locating rules separately for each event. Thus, Magnus may specify a different primary device and/or rules for the Staff Meeting called by Helena (e.g., event record 652) than other event. In this embodiment, parameters table 700 may include a field for specifying the event to which the corresponding parameters apply. In yet another embodiment, a user may specify a primary device, other devices, and locating rules separately for each type of event (e.g., as identified by a BUSINESS tag or a SOCIAL tag). Thus, Magnus may specify a different primary device and/or rules for business meetings than social outings. In this embodiment, parameters table 700 may include a field for specifying the event type to which the corresponding parameters apply.

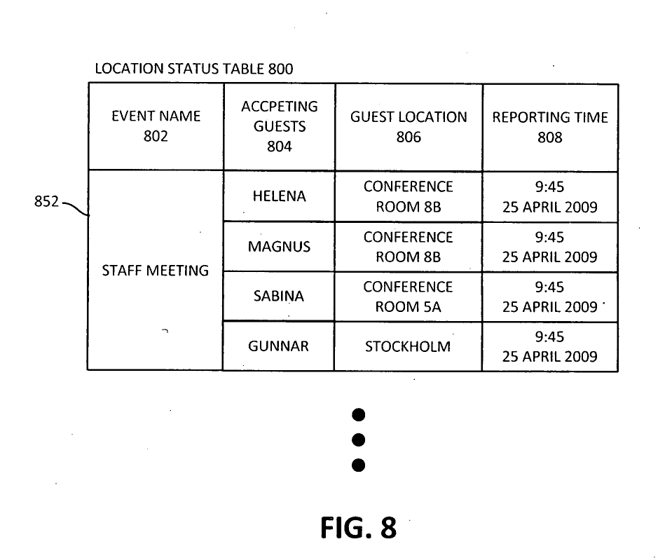

FIG. 8 is a block diagram of an exemplary location status table 800 (or “status table 800”). Status table 800 may store location information related to guests that have accepted invitations to events, for example. Each entry (e.g., record) in status table 800 may include information regarding a different event and guests expected to attend the event. Status table 800 may be stored in sync server 110 (e.g., in memory 460). In other embodiments, status table 800 may also be stored in another device in environment 100, such as Helena's computer 102 (e.g., a host's device) or a guest's device (e.g., devices 104-109). Status table 800 may include an event name field 802, an accepting guests field 804, and a guest location field 806, and a reporting time field 808.

Event name field 802 may include the name or description of the event. For example, status table 800 includes STAFF MEETING as an event (e.g., record 852). This meeting may correspond to the staff meeting in record 652 of event table 600, for example, as both have the same name.

Accepting guests field 804 may specify the guests that have accepted the invitation to attend the corresponding event. Guest location field 806 may specify the location of the corresponding guest in accepting guests field 804. Reporting time field 808 may specify the time the corresponding guest (e.g. guest device) reported his or her location for guest location field 806. For example, in exemplary location status table 800, Magnus (field 804) was reportedly in conference room 8B (field 806) at 9:45 on Apr. 25, 2009 (field 808). This reporting time (e.g. 9:45 on Apr. 25, 2009) corresponds to the opening of the alert window for the staff meeting specified in record 652 of event table 600.

Status table 800 may include additional, different, or fewer fields than illustrated in FIG. 8. For example, status table 800 may include a field indicating the user device that reported the guest's location. Status table 800 may also include a field to indicate the rule (e.g. a rule in locating rules 708) used to determine the location of the guests. In one embodiment, status table 800 may include a field for storing the acceleration and/or velocity of the device from which the corresponding location was determined.

### Exemplary Processes for Event Scheduling

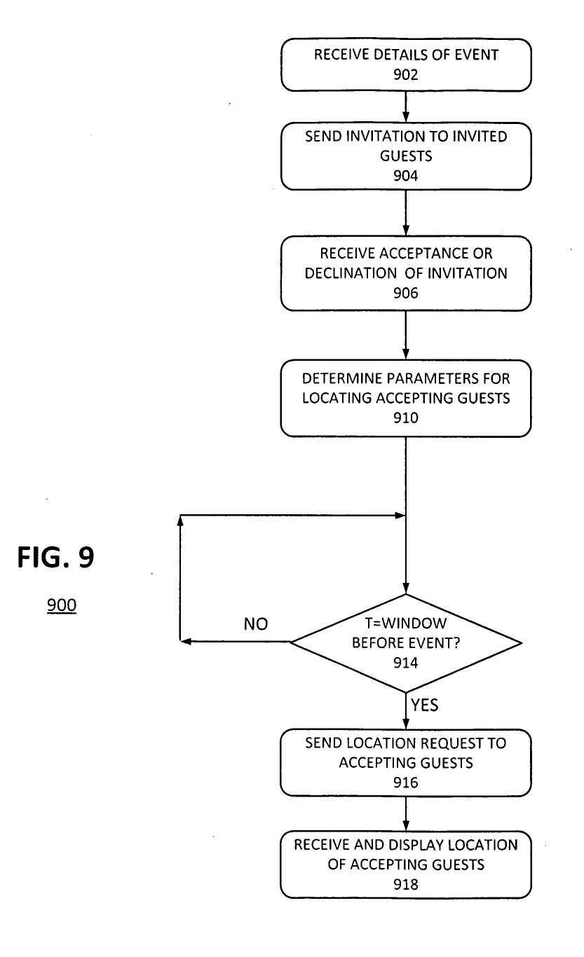

FIG. 9 is flowchart of an exemplary process 900 for event scheduling with location management. Process 900 may begin with the receipt of the details of an event (block 902), such as a meeting. For example, a host (e.g., the person calling the event or meeting) may wish to invite a number of guests to a meeting. In the example of FIG. 1, Helena (the host) may wish to invite herself, Magnus, Sabina, Gunnar, and John to a Staff Meeting to be held in at 10:00 in conference room 8B, on Apr. 25, 2009.

In one embodiment, the details of the event may be received by an application running in a client computing module, such as client computing module 300 in Helena's computer 102. In this example, Helena's computer 102 may be running a personal information manager (PIM) application, such as Microsoft Outlook or Novell Evolution, which may receive the event details input by Helena. The received details may include, for example, the event name, the host name, the event time, an alert window, and a list of the invited guests. These details may correspond to some of the fields of event table 600. In one embodiment, the received details include the event location, such as Conference Room 8B (see, e.g., record 652). The host (e.g., Helena) may select the event location from a database, such as place table 500, or from a map, such as Google or Yahoo maps. In another embodiment, discussed below, the received details do not include the event location. The host may also select an alert window (e.g. a set period of time) before the time of the corresponding event that the location of accepting guests 612 (described below) should be determined. In one embodiment, if an alert window is not specified, then a default alert window (e.g., 15 minutes) may be assumed. Computer 102 may create a calendar entry for the requested meeting in Helena's calendar, which may be synchronized to Helena's calendar stored in sync server 110 (e.g., using ActiveSync). In other words, Helena's computer 102 and sync server 110 may create record 652 in event table 600 corresponding to the Staff Meeting.

An invitation to the event may be sent to the invited guests (block 904). For example, computer 102 or sync server 110 may form a message (e.g., an email message with the received event details) for sending to the invited guests. The email may be sent via sync server 110, for example, about the same time sync server 110 creates a record in event table 600.

The invitation may be received by one or more of the devices associated with the invited guests. For example, Magnus, Sabina, Gunnar, and John may receive an invitation (e.g., from the host Helena) to the Staff Meeting (e.g., record 652) in an email at Magnus's mobile device 104, Sabina mobile device 106, Gunnar's mobile device 108, and John's computer 109, respectively. The invitations may be received at other devices associated with the guests. For example, if Magnus is using his laptop, he may receive the invitation email at his laptop rather than (or in addition to) his mobile device 104.

The invited guests may choose to accept the invitation or decline the invitation. For example, each invited guest may respond to the invitation with an email accepting or declining the invitation. As such, the acceptance or declination of the invitations may be received (block 906) by, for example, sync server 110. Sync server 110 may indicate acceptances and declinations in fields 612 and 614, respectively. For example, as shown in event table 600, Magnus, Sabina, and Gunnar may accept the invitation to the Staff Meeting, whereas John may decline the invitation. A change of state of event table 600 may prompt synchronization between sync server 110 and Helena's computer 102, for example, so that Helena is aware of the users who have accepted or declined the invitation to the Staff Meeting. Synchronization may also occur between sync server 110 and other devices, such as all the devices associated with invited guests. Event table 600 may record Helena as an accepting guest to the Staff Meeting (e.g., accepting guests field 612 of record 652) because Helena is the host of the event and presumably will attend. In other embodiments, it is not presumed that the host is an accepting guest.

For the invited guests who accept the invitation, the parameters for locating the invited guest may be determined (block 910). For example, Magnus may be associated with mobile device 104 as a primary device (record 754, field 704), computer 784 and MID 782 (field 706) as other devices, and a set of rules (field 708) as locating rules. As such, the parameters for locating Magnus, as an invited guest, has been determined. If a user is not associated with a primary device (field 704), other devices (field 706), or any rules (field 708), then the corresponding user may be prompted to identify parameters for locating the user. For example, parameters table 700 does not associate Gunnar (record 758) with a primary device, other devices, or locating rules. Gunner may be prompted to identify parameters for table 700. Gunnar may, for example, use a web browser in computer 108 to interact with sync server 110 to populate the fields of record 758 associated with him. As discussed above with respect to FIG. 7, locating parameters table 700 may apply for every event for each user, or the user may also specify locating parameters for each event.

At the opening of a window of time before the meeting (block 914: YES), a location request may be sent to devices associated with accepting guests (block 916). For example, at 9:45 on Apr. 25, 2009 (e.g., the alert window of 15 minutes before the event time as specified in record 652), sync server 110 may send location requests to the guests listed in accepting guests field 612 (block 916). In the case of Magnus (record 756), according to rule 1, a location request may be sent to mobile device 104. Upon receipt of the location request, a message may be displayed on mobile device 104, such as the message on display 204 of device 200 in FIG. 2, alerting the guest of the pending event.

As shown in FIG. 2, in one embodiment, the guest may be prompted regarding whether to send a response to the location request (e.g., a location update message). For example, display 204 in FIG. 2 asks the user whether to “inform host of current location?” In the current example, Magnus may select YES (e.g., by using control keys 206 or touch screen 204) and then his mobile device 104 may send a response to the location request (e.g., a location update message). A user may select NO, however, and a response is not sent. In one embodiment, if the user does not respond with YES or NO, then the device may respond automatically after a period of time, such as one minute. If mobile device 104 sends a response, it may send its location coordinates (e.g., based on its GPS coordinates from its GPS receiver and associated logic). In one embodiment, GPS data may be sent to sync server 110 using GPX (GPS Exchange Format) over any number of protocols, such as XMPP and/or TCP. In one embodiment, the ActiveSync protocol may be extended to include the synchronization of location information. The location information may include acceleration or velocity information from, for example, an accelerometer located in the device or calculated based on the change of location over a period of time.

In another embodiment, location information may be sent without prompting the user as shown in FIG. 2. In yet another embodiment, the device may send location information without being prompted with a location request. In this embodiment, the user device may send location information at the opening of the window before the event (e.g., based on an internal clock) without prompting (e.g., without receiving a location request). In another embodiment, the user device may send location information continuously, or on a periodic basis, at the opening of the window before the event either in response to a location request from sync server 110 or without a location request. In yet another embodiment, the user device may send location information repeatedly, but more frequently as the event time approaches. For example, the location information may be sent at 15 minutes, then at 10, 8, 5, 3, 2, and 1 minutes before the event time. In one embodiment, location information may be requested and/or sent after the start of the event (e.g., at 5 minutes after the event). In this embodiment, location information may be requested and/or sent less frequently as time passes (e.g., at 1 minute, then at 2, 3, 5, 8, 10, and 15 minutes after the event time.

Returning to the example, as discussed above, Magnus (e.g., Magnus's mobile device 104) may receive and respond to the location request at the opening of the window before the event. The other accepting guests may also receive location requests. According to exemplary event table 600, sync server 110 may also send a location request to each of Sabina, Gunnar, and Helena. In the case of Helena, sync server 110 may send a location request to Helena's computer 102 if she is logged in (see rule 1, record 752 of FIG. 7). In one embodiment, Helena's location may be determined by where computer 102 has connected to the network (e.g., by the MAC address, IP address, or the location of a wireless router or BTS communicating with computer 102). If Helena is not logged in, sync server 110 may send a location request to Helena's primary device (see rule 2 of record 752 of FIG. 7). Likewise, a location request may be sent to Sabina's mobile device 106 (see rule 1 of record 756). Although Gunnar has not specified a primary device, other device, or locating rules, a location request may be sent to mobile device 108 by default, as it is the only device belonging to Gunnar shown in environment 100 or because it is the device that Gunnar used to respond to the event invitation.

The location information may be received by the sync server (block 918). For example, sync server 110 may receive the location information from each of the accepting guests and may store this information in location status table 800. As shown in exemplary status table 800, 15 minutes before the Staff Meeting, Magnus and Helena are already in conference room 8B where the meeting is to take place. Sabina is in Conference Room 5A while Gunnar is in Stockholm.

Location information of accepting invitees may be displayed (block 918). As shown in FIG. 1, Helena may view the locations of accepting guests before the Staff Meeting. In this example, Magnus is at the meeting and Sabina is within 15 minutes of the meeting location. Gunnar is more than 15 minutes away from the location of the Staff Meeting and, at best, will likely be late to the meeting. In this embodiment, Sabina's and Gunnar's exact locations are not shown for privacy reasons. In another embodiment, Sabina's and Gunnar's locations may be displayed, or may be displayed depending on the privileges of the account of the person viewing the information. Although a guest's exact location may not be displayed, sync server 110 may determine whether the guest's location would permit him or her to arrive at the event location by the start time of the event (e.g., whether or not the guest is too far from the location to reasonably be expected to arrive on time). Thus, exemplary display 103 of FIG. 1 indicates that Sabina's current location would allow her to arrive at the meeting location on time, whereas Gunner's current location would not allow him to arrive at the meeting location on time.

In one embodiment, all guests, or all accepting guests, may be permitted to view the information stored in status table 800. In another embodiment, only the host (e.g., Helena) or individuals selected by the host may be allowed to view the information stored in status table 800. In yet another embodiment, the distance from the event location (e.g., in miles, kilometers, etc.) to each accepting guest may be displayed, rather than the exact location of each accepting guest.

The locations of the accepting guests and the meeting location may be displayed on a map, such as a map obtained from Google or Yahoo maps. In one embodiment, each accepting guest may also receive a route explaining how the corresponding guest may navigate to the meeting. In this embodiment, each inviting guest would potentially receive a different route, depending on his or her location relative to the meeting place.

In one embodiment, an alternative meeting location may be recommended. For example, sync server 110 may analyze the locations of accepting guests (e.g., field 806), the event location (e.g., field 606 of event table 600), and alternative locations (e.g., locations stored in place table 500). In this embodiment, sync server 110 may recommend an alternative location if, for example, an alternative location (e.g., stored in place table 500) is closer to the accepting guests than the location stored in event table 600. For example, sync server 110 may recommend conference room 5A if all the accepting guests were on the fifth floor and conference room 5A was not booked. In this embodiment, the host (e.g., Helena) or the accepting guests may accept or decline the recommended new event location.

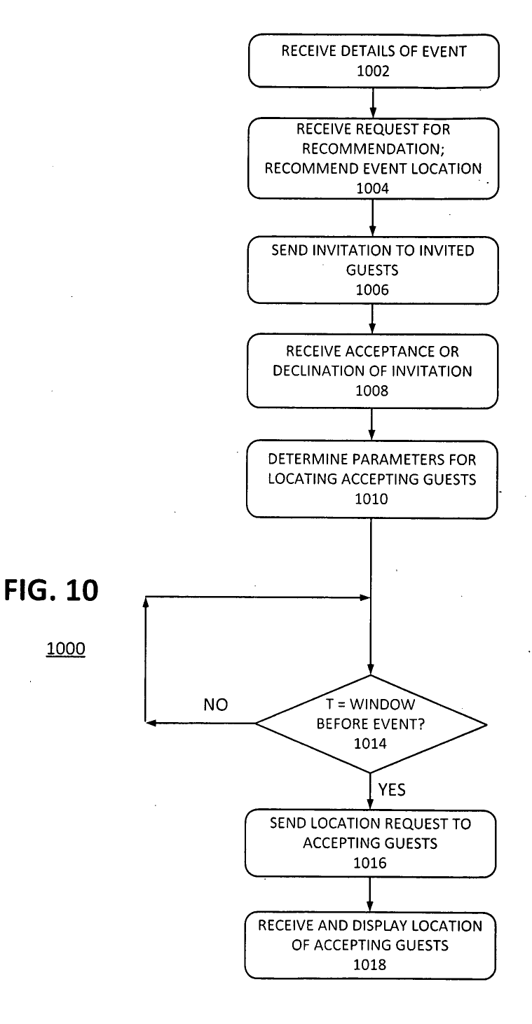

FIG. 10 is a flowchart of an exemplary process 1000 for scheduling events with location management. Process 1000 may begin with the receipt of the details of a meeting, including invitees (block 1002). In this embodiment, however, a location for the event may be omitted. Instead, an event location may be recommended by, for example, sync server 110. In the following example, Magnus may wish to invite himself, Sabina, and John out for a night on the town on Friday, May 1, 2009, at 23:00 in Stockholm to get away from their manager Helena.

In this example, the details of the event (e.g., a Night Out in Stockholm) may be received by a PIM application running in a client computing module, such as in Magnus's mobile device 104. The received details may include, for example, the event name, the host name, the event time, and a list of the invited guests. These details may correspond to some of the fields of event table 600. Magnus's mobile device 104 may create a calendar entry for the requested meeting in Magnus's calendar, which may be synchronized to his calendar stored in sync server 110. In other words, sync server 110 may create record 658 in event table 600 corresponding to the Night Out in Stockholm.

A request for a recommendation may be received, and a location for the event may be recommended (block 1004). In the above example, Magnus may not know Sabina's or John's preferences for spending the night out in Stockholm and may request a recommendation. In this case, sync server 110 may analyze the social location preferences of Magnus, Sabina, and John. Because Mest appears in each preference list for each person, sync server 110 selects Mest as the meeting location. In one embodiment, sync server 110 may request confirmation from Magnus that the selection of an event location satisfies Magnus. In another embodiment, Magnus may request, and sync server 110 may recommend more than one location for the event. In yet another embodiment, sync server 110 may consider other events in event table 600 (e.g., events on the calendars of invited guests) in selecting the event location. In this embodiment, sync server 110 may choose not only a location according to preferences, but a location that each invited guest may navigate to in a safe and timely manner (e.g., there is no event in Magnus's, Sabina's, or John's calendar before the Night out In Stockholm that is too far away from the recommended location for any of them to travel to in a timely manner). If no such location exists, then sync server 110 may recommend that the event take place at a different time (and may recommend a different time). Even if such a location exists, sync server 110 may recommend a different time if a more convenient location exists.

An invitation to the event may be sent to the invited guests (block 1006). For example, sync server 110 may form a message (e.g., an email message with the event details) for sending to the invited guests. The email may be sent via sync server 110, for example, and sync server 110 may create a record in event table 600.

The invitation may be received by one or more of the devices associated with the invited guests. For example, Sabina and John may receive an invitation to a night out in Stockholm (e.g., record 658) in an email at any of their devices, such as Sabina's mobile device 106 and John's mobile device 109, respectively.

The invited guests may choose to accept the invitation or decline the invitation and the acceptance or declination of the invitation may be received (block 1008) by, for example, sync server 110. Sync server 110 may indicate acceptances and declinations in fields 612 and 614, respectively. In this example, as shown in event table 600, Sabina and John accepted the invitation for a Night Out in Stockholm. In one embodiment, should one of the invited guests decline the invitation, a new recommendation for a location for the event may be generated by sync server 110. In this embodiment, the sync server 110 may ignore the declining guest's location preferences, since that guest will not be attending the event. In the embodiment, described above, in which sync server 110 selects multiple event locations, the invited guests (or only the accepting guests) may vote on the event locations and the location receiving the most votes may be the recommended location.

For the invited guests who accept the invitation, the parameters for locating the invited guest may be determined (block 1010), similar to block 910 of FIG. 9, described above. At the opening of a window of time before the event (block 1014: YES), a location request may be sent to devices associated with accepting guests (block 1016), as discussed above with respect to blocks 914 and 916 of FIG. 9. After receiving location information from the guests, this location information may be displayed (block 1018), as discussed above with respect to block 918 of FIG. 9.

In the social example of FIG. 10, Magnus, Sabina, and John may not have a common sync server if, for example, they do not work at the same place of business (e.g., they do not have a common Microsoft Exchange server or email server). In this case, Magnus's mobile device 104 may act as a sync server. Alternatively, Magnus's wireless carrier may provide the services of sync server 110.

### Conclusion

The foregoing description of implementations provides illustration, but is not intended to be exhaustive or to limit the implementations to the precise form disclosed. Modifications and variations are possible in light of the above teachings or may be acquired from practice of the teachings.

For example, while series of blocks have been described with regard to the exemplary processes illustrated in FIGS. 9 and 10, the order of the blocks may be modified in other implementations. In addition, non-dependent blocks may represent acts that can be performed in parallel to other blocks.

Aspects described herein may be implemented in many different forms of software, firmware, and hardware in the implementations illustrated in the figures. The actual software code or specialized control hardware used to implement aspects does not limit the invention. Thus, the operation and behavior of the aspects were described without reference to the specific software code—it being understood that software and control hardware can be designed to implement the aspects based on the description herein.

The term “comprises/comprising,” as used herein, specifies the presence of stated features, integers, steps or components but does not preclude the presence or addition of one or more other features, integers, steps, components, or groups thereof.

Further, certain portions of the implementations have been described as “logic” that performs one or more functions. This logic may include hardware, such as a processor, a microprocessor, an application specific integrated circuit, or a field programmable gate array, software, or a combination of hardware and software.

No element, act, or instruction used in the present application should be construed as critical or essential to the implementations described herein unless explicitly described as such. Also, as used herein, the article “a” is intended to include one or more items. Further, the phrase “based on” is intended to mean “based, at least in part, on” unless explicitly stated otherwise.

What is claimed is:

1. A computer-implemented method comprising:
associating each of a plurality of guests with an event time and an event location, wherein the association of each of the plurality of guests includes information indicating whether the guest is expected to be present at the event location at the event time, and wherein the event time and the event location is the same for each of the plurality of guests;
associating each of a plurality of mobile devices with a different one of the plurality of guests that is associated with information indicating that the guest is expected to be present at the event location at the event time;
receiving a location update message from each of the mobile devices, wherein each location update message indicates a location of the corresponding mobile device; and
displaying an indication of the location of the each of the mobile devices as indicative of the location of the associated guest.

2. The computer-implemented method of claim 1, further comprising:
determining, for one of the mobile devices, a distance between the location of the one mobile device and the event location;
determining, based on the distance, whether the guest associated with the one mobile device, when collocated with the one mobile device, is unlikely to be present at the event location at the event time; and
displaying the determination of whether the guest associated with the one mobile device is unlikely to be present at the event location at the event time.

3. The computer-implemented method of claim 1, comprising:
sending a location request message to each of the mobile devices, wherein each location request message requests the location of the corresponding mobile device; and
wherein the location update message received from each of the mobile devices is in response to the location request message sent to each of the mobile devices.

4. The computer-implemented method of claim 3, wherein sending the location request message includes sending the location request message at a set period of time before or after the event time, wherein the set period of time is one of approximately 5 minutes, 10 minutes, 15 minutes, 20 minutes, 30 minutes, 45 minutes, or 60 minutes.

5. The computer-implemented method of claim 3, further comprising:
analyzing, after receiving the location update message from each of the mobile devices, the location of each mobile device relative to the event location; and
recommending a new event location based on the analysis.

6. The computer-implemented method of claim 5, further comprising:
recommending the new event location based on stored location preferences of one or more of the plurality of guests or based on previous event locations associated with one or more of the plurality of guests.

7. A system comprising:
a database to store:
an association between each of a plurality of guests and an event time and an event location, wherein the association of each of the plurality of guests indicates whether the guest is expected to be present at the event location at the event time;
an association between each of a plurality of mobile devices and a different one of the plurality of guests associated with information indicating that the guest is expected to be present at the event location at the event time;
a receiver to receive a location update message from one or more of the plurality of mobile devices, wherein each location update message indicates a location of the corresponding mobile device; and
a display to show an indication of the location of the one or more mobile devices and the associated guest.

8. The system of claim 7, further comprising:
a processor to:
determine, for each of the one or more mobile devices, a distance between the location of the mobile device and the event location, and
determine, based on the distance, whether one or more of the guests, when collocated with the associated mobile device, is unlikely to be present at the event location at the event time;
wherein the display shows one or more of the determinations.

9. The system of claim 7, comprising:
a transmitter to send a location request message to the one or more mobile devices, wherein each location request message requests the location of the corresponding mobile device, wherein the location update messages received from the one or more mobile devices is in response to the transmitter sending the location request message to the one or more mobile devices.

10. The system of claim 9, wherein the transmitter sends the location request message at a set period of time before or after the event time, wherein the set period of time is one of approximately 5 minutes, 10 minutes, 15 minutes, 20 minutes, 30 minutes, 45 minutes, or 60 minutes.

11. The system of claim 7, wherein the processor analyzes, after receiving the location update message from the one or more mobile devices, the location of each of the one or more mobile devices relative to the event location, and recommends a new event location based on the analysis.

12. The system of claim 11, wherein the processor recommends the new event location based on stored location preferences of one or more of the plurality of guests or based on previous event locations associated with one or more of the plurality of guests.

13. A mobile device comprising:
a receiver to receive an invitation to be present at an event location at an event time; and
a transmitter to send a response to the invitation to a sync server, wherein the response includes an indication that a guest associated with the mobile device is expected to be present at the event location at the event time,
wherein the transmitter is further configured to send a location update message to the sync server indicating a location of the mobile device, wherein the location of the mobile device is indicative of the location of the guest associated with the mobile device.

14. The mobile device of claim 13, wherein the receiver is further configured to receive a request for the location of the mobile device, wherein the transmitter sends the location update message is in response to the request.

15. The mobile device of claim 13, wherein the receiver is further configured to receive a recommendation of a new event location based on stored location preferences of associated with the mobile device or based on previous event locations associated with the mobile device.

16. A computer-readable medium including computer-executable instructions for:
associating each of a plurality of guests with an event time and an event location, wherein the event time and the event location is the same for each of the plurality of guests;
storing information indicating that one or more of the plurality of guests is expected to be present at the event location at the event time;
associating each of one or more mobile devices with a different one of the one or more guests that indicate that the guest is expected to be present at the event at the event location;
receiving a location update message from each of the one or more mobile devices, wherein each location update message indicates a location of the corresponding mobile device; and
displaying an indication of the location of each of the one or more mobile devices as indicative of the location of the associated guest.

17. The computer-readable medium of claim 16, further comprising computer-executable instructions for:
determining a distance between the location of one of the mobile devices and the event location;
determining, based on the distance, whether the guest associated with the one of the mobile devices, when collocated with the one of the mobile devices, is unlikely to be present at the event location at the event time; and
displaying the determination.

18. The computer-readable medium of claim 16, further comprising computer-executable instructions for:
sending a location request message to the one or more mobile devices, wherein the location request message requests the location of the corresponding mobile device, and wherein the location update message received from the one or more mobile devices is in response to sending the location request message to the one or more mobile devices.

19. The computer-readable medium of claim 18, wherein sending the location request message includes sending the location request message at a set time before or after the event time, wherein the set period of time is one of approximately 5 minutes, 10 minutes, 15 minutes, 20 minutes, 30 minutes, 45 minutes, or 60 minutes.

20. The computer-readable medium of claim 19, further comprising computer-executable instructions for:
analyzing, after receiving the location update message from the one or more mobile devices, the location of the one or more mobile devices relative to the event location; and
recommending a new event location based on the analysis.
